(19) United States
(12) Patent Application Publication
(10) Pub. No.: US 2007/0266435 A1
(43) Pub. Date: Nov. 15, 2007

(54) SYSTEM AND METHOD FOR INTRUSION DETECTION IN A COMPUTER SYSTEM

(76) Inventors: Paul D. Williams, Dayton, OH (US); Eugene H. Spafford, West Lafayette, IN (US)

Correspondence Address: BARNES & THORNBURG LLP, 11 SOUTH MERIDIAN, INDIANAPOLIS, IN, 46204, US

(21) Appl. No.: 11/616,615

(22) Filed: Dec. 27, 2006

Related U.S. Application Data
(60) Provisional application No. 60/754,488, filed on Dec. 28, 2005.

(51) Int. Cl. G06F 12/14

(52) U.S. Cl. 726/22; 726/26

(57) ABSTRACT

A computer system for intrusion detection includes a production processor and a security processor. The production processor is configured to execute one or more production processes. The security processor is dedicated to security functions and is configured to execute one or more security processes. The security process is configured to monitor the functions of the production processor and determine the occurrence of a security event. The security event may include any action performed by the production process that is considered to be threat to the security of the computer system. In some embodiments, the security process is associated with a particular production process and is configured to utilize information concerning the expected behavior of the production process while monitoring for security events.

### CROSS REFERENCE TO RELATED APPLICATIONS

This application claims priority under 35 U.S.C. § 119(e) to U.S. Provisional Application Ser. No. 60/754,488, filed on Dec. 28, 2005, incorporated herein by reference.

### GOVERNMENT RIGHTS

The invention described herein may be manufactured and used by or for the Government of the United States for all governmental purposes without the payment of any royalty.

### TECHNICAL FIELD

The present disclosure relates generally to intrusion detection systems, and more particularly to intrusion detection systems for multiprocessor computer systems.

### BACKGROUND OF THE INVENTION

An intrusion detection system is a software and/or hardware device used in a computer system to detect unauthorized access to, misuse of, or other unauthorized interaction with the protected computer system. Among other activities, an intrusion detection system may detect attacks, detect intrusions, detect misuse, or perform computer forensics to determine historical circumstances of the attack, intrusion, or misuse. In addition, the intrusion detection system may respond to the attack, intrusion, and/or misuse. The intrusion detection system may detect and/or respond in real-time, in near real-time, periodically, or retrospectively.

Typical intrusion detection systems are designed for and implemented in single processor computer systems. In such single processor systems, only one instruction stream is processed at any given point in time. If the single processor computer system is compromised, any existing malicious code is executed in isolation from the intrusion detection system thereby providing the malicious code with opportunities to affect the system and/or destroy traces of its actions before the single processor intrusion detection system can detect or respond to the security breach.

Some intrusion detection systems are implemented on multiprocessor computer systems. In typical multiprocessor systems, all tasks, including the security code of the instruction detection system, are divided amongst the processors according to some criteria such as workload. Accordingly, even in such multiprocessor computer systems, malicious code may be executed prior to the intrusion detection system detecting or responding to the security breach because each processor may be executing both production code (e.g., word processor, spreadsheet program, web server, etc.) and security code similar to single processor computer systems.

### SUMMARY OF THE INVENTION

The present invention comprises one or more of the features recited in the appended claims and/or the following features which, alone or in any combination, may comprise patentable subject matter:

According to one aspect, a multiprocessor computer includes a first processor and a second processor. The first processor configured to execute a production process such as, for example, an operating system, a web server program, a network management program, a data management program, or the like. The second processor may be electrically coupled to the first processor. The second processor may be configured to execute a security process associated with the production process. The security process may cause the second processor to monitor the operations of the first processor for an occurrence of a security event. In some embodiments, the second processor is dedicated to security related processes. Additionally, in some embodiments, the first and second processors may be configured for symmetric multiprocessing.

The second processor may be configured to execute the security process prior to the execution of the production process by the first processor. The security process may monitor the operations of the first processor for an occurrence of the security event by, for example, determining if a predetermined variable is modified to an invalid value by the production process. In some embodiments, the security process may cause the second processor to halt the execution of the production process if the security event occurs. The security process may also cause the second processor to copy data from a memory location of the second processor to a memory location of the first processor if the security event occurs. Additionally, the security process may cause the second processor to monitor a register of the first processor and may generate an alert if the security event occurs. The security event may be embodied as any operation or action of the first processor or production process that threatens the security of the computer system. For example, the security event may be embodied as an overflow error.

The production process may include any number of checkpoints. If so, the production process may cause the first processor to communicate with the second processor when a checkpoint is reached. The production process may also cause the first processor to communicate with the second processor prior to performing a predetermined operation.

According to another aspect, a method for detecting a security event on a multiprocessor computer may include executing a production process on a first processor of the multiprocessor computer and executing a security process on a second processor of the multiprocessor computer. The method may also include monitoring the operations of the production process using the security process for an occurrence of the security event. The security process may be executed prior to the production process. The operations of the production process may be monitored by, for example, monitoring a predetermined variable used by the production process and generating an alert if the variable is modified by the production process to an invalid value. Additionally or alternatively, monitoring the operations of the production process may include monitoring a register used by the first processes. In some embodiments, the execution of the production process may be halted if the security event occurs. Additionally, if a security event occurs, data from a memory location of the second processor may be copied to a memory location of the first processor if the security event occurs. Further, in some embodiments, the method may include generating an alert if the security event occurs.

The above and other features of the present disclosure, which alone or in any combination may comprise patentable subject matter, will become apparent from the following description and the attached drawings.

### BRIEF DESCRIPTION OF THE DRAWINGS

The detailed description particularly refers to the following figures, in which:

FIG. 1 is a block diagram of a system architecture of a computer system having multiple processors;

FIG. 2 is a block diagram of a software architecture for use by the computer system of FIG. 1;

FIG. 3 is a diagram of a program process executed on the computer system of FIG. 1;

FIG. 4 is a process flow diagram of an algorithm for loading a program process on the computer system of FIG. 1;

FIG. 5 is a process flow diagram of an algorithm for invariant testing of variables executed on the computer system of FIG. 1;

FIG. 6 is a process flow diagram of a protection algorithm executed on the computer system of FIG. 1; and

FIG. 7 is a process flow diagram of an algorithm for responding to a security event executed on the computer system of FIG. 1.

### DETAILED DESCRIPTION OF THE DRAWINGS

While the concepts of the present disclosure are susceptible to various modifications and alternative forms, specific exemplary embodiments thereof have been shown by way of example in the drawings and will herein be described in detail. It should be understood, however, that there is no intent to limit the concepts of the present disclosure to the particular forms disclosed, but on the contrary, the intention is to cover all modifications, equivalents, and alternatives falling within the spirit and scope of the disclosure.

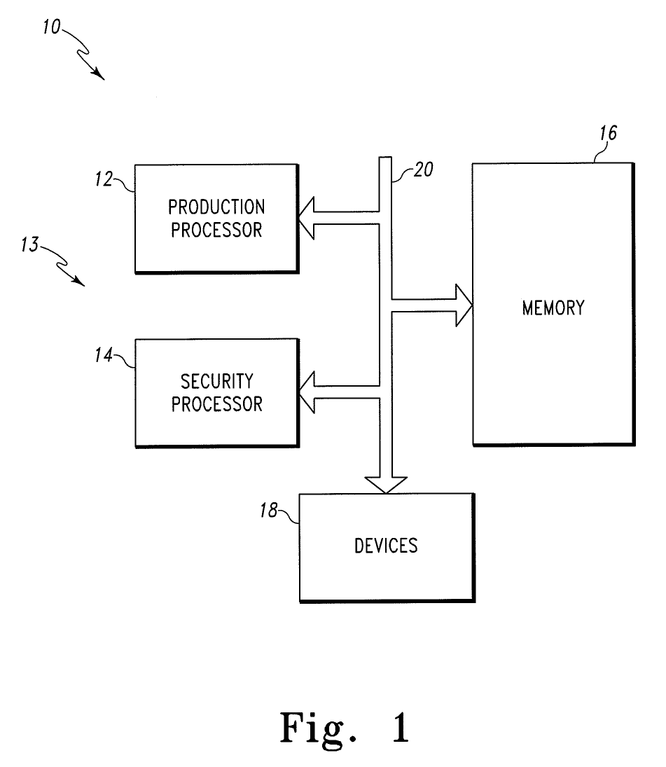

As illustrated in FIG. 1, a multiprocessor computer system 10 includes a number of processors 13, a memory device 16, and a number of associated devices 18 such as display monitors, keyboards, data storage devices, and the like. The processors 13, device 16, and devices 18 are interconnected via a system bus 20. In the illustrative embodiment, the system 10 is a general purpose symmetrical multiprocessing (SMP) computer system. In such systems, the processors 13 share the system resources such as memory device 16 and devices 18. However, in other embodiments, the system 10 may be an asymmetrical multiprocessing (ASMP) computer system with a master processor and a number of slave processors.

In the illustrative system 10, the processors 13 include a production processor 12 and a security processor 14. However, in other embodiments, the system 10 may include any number of additional production processors 12 and/or security processors 16. The production processor 12 executes production processes. A production process includes any software code, or portion thereof, and associated data structures for which the system 10 is intended. For example, the production processor 12 may execute an operating system, a word processor program, a spreadsheet program, a data management program, a web server program, or any other type of program and/or combination thereof.

In the system 10, the security processor 14 is dedicated to security functions. Accordingly, the security processor 14 executes one or more security processes. The security process(es) may be embodied as general security software code configured for the system 10 and/or as security software code specifically designed for and associated with a particular production process that is executed on the production processor 12. For example, each production process executed on the production processor 12 may have an associated security process that is contemporaneously executed on the security processor 14. In one particular embodiment, the security processor 14 executes substantially only security related code. Accordingly, although the illustrative system 10 is an SMP system, the production processor 12 and security processor 14 are used asymmetrically based on whether the process is a production process or a security process.

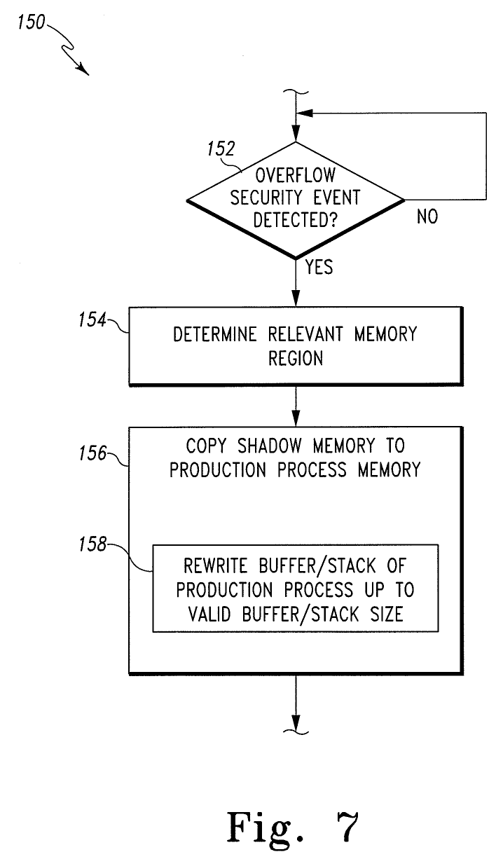

In use, the security processor 14, which is executing one or more security processes, monitors the operation of the production processor 12 for a security event. A security event includes any action performed by the production processor 12 or production process that is considered to be threat to the security of the computer system 10. For example, a security event may include a changing of the value of a variable to an invalid value, a jump to a memory location outside of a valid range, a buffer or stack overflow, and/or any other event that has been determined to be a threat to the computer system 10. Once the security processor 14 detects a security event, the security processor 14 may be configured to perform a set of predetermined functions to protect the computer system 12 from the threat generating the security event and, in some embodiments as discussed below in regard to FIG. 7, perform a “self-heal” function to restore the computer system 12 to a safe operation state.

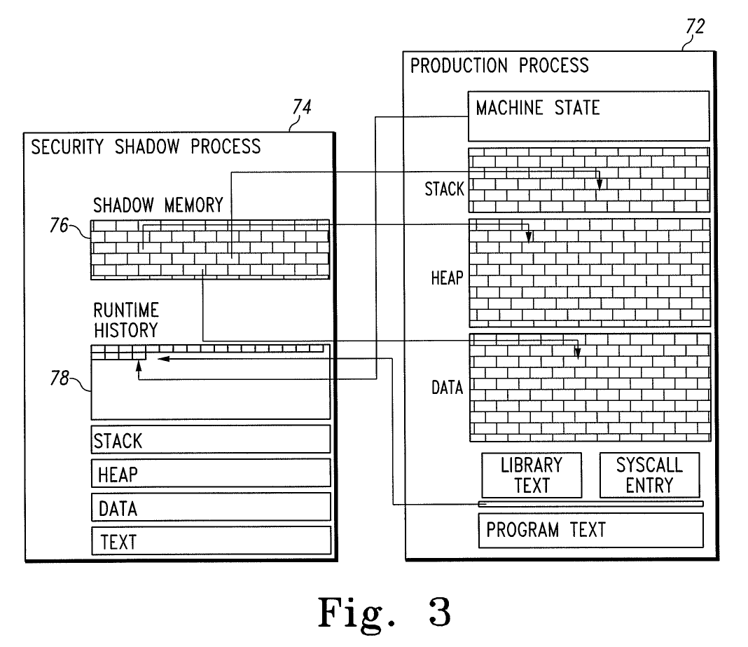

To monitor the operation of the production processor for a security event, the security processor 14 may perform a number of security functions such as, for example, validating the production process and associated security process prior to startup and shutdown of the production process, monitoring data provided to the security process by the production process, monitoring variables of the production process identified as critical for changes outside of a predetermined range, monitoring the function calls of the production process, monitoring other interactions by the production process with external environmental entities such as runtime libraries and operating systems, and/or the like. As discussed above, the security processor 14 may execute a general security process and/or one more specialized security processes associated with particular production processes to perform these functions. As discussed below in regard to FIG. 3, when the security processor 14 is executing a security process associated with a particular production process, knowledge of the intended actions and functions of the production process may be used by the security process to determine if a security event has occurred.

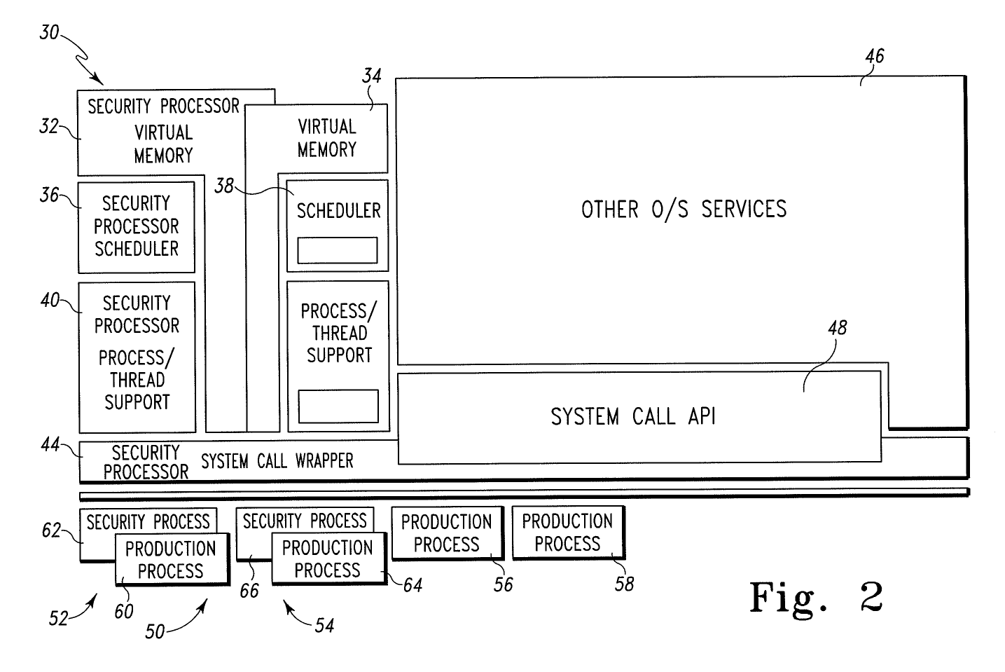

Referring now to FIG. 2, to provide an amount of visibility of the operations of the production process to the security process, the virtual memory of the security process may include a portion of the virtual memory of the production process. For example, one embodiment of a software architecture 30 used by the computer system 10 includes separate virtual memories 32, 34, schedulers 36, 38, and process/thread supports 40, 42 for the production processor 12 and the security processor 14, respectively. As illustrated in FIG. 2, the operating system of the system 10 may be divided up into separate components that are executed on separate processors depending on the component's function, importance, and/or susceptibility. For example, if the particular component relates to security, the component is executed by the security processor 14. Other operating system components/services 46 that do not relate to security functions are executed by the production processor 12.

In addition, a system call wrapper 44 is executed by the security processor 14. The wrapper 44 interfaces with a system call application program interface (API) 48 executed on the production processor 12. The wrapper 44 allows the security processor 14 to monitor system calls performed by the production processor 12. Similarly, the virtual memory 32 of the security processor 32 overlaps a portion of the virtual memory 34 of the production processor 12 to allow the security processor 32 to monitor important locations of the memory 34 of the production processor 12. In addition, the software architecture 30 may include other components commonly found in operating systems.

A number of production processes 50 may be executed by the production processor 14. As discussed above, each production process 52, 54, 56, 58 may be a separate process of a single program such as a web server program. Some production processes 52, 54 may be identified as attack vulnerable, security sensitive, or otherwise protected processes. For each of these processes 52, 54, an associated security process 62, 66, respectively, is executed on the security processor 14. The associated security processes 62, 66 are separate security processes configured for and associated with each production process 60, 64 and are typically not identical. However, in other embodiments, the security processes 62, 66 may be identical security processes that are executed along with any security sensitive production process 60, 64.

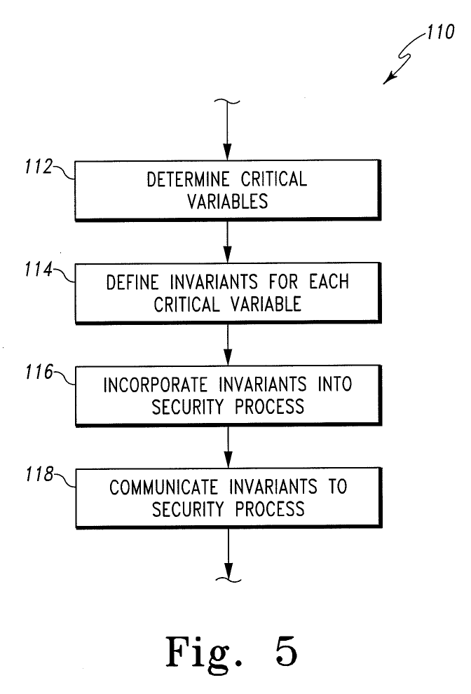

As illustrated in FIG. 3, if a production process 72 is identified as security sensitive, a security “shadow” process 74 is executed contemporaneously with the production process 72. As described above, the production process 72 is executed by the production processor 12 of the computer system 10 and the security process 74 is executed by the security processor 14. The production process 72 contains the program code and data structures used to accomplish the tasks for which the program was designed such as web services or data routing. In addition, the production process 72 may contain code and data structures for communicating information relating to security, such as the state of the production process 72, to the security process 74 as discussed in more detail below in regard to FIG. 5. The security process 74 contains code and data structures which monitor the activities of the production process 72 including, for example, modification of variables, writing operations to buffers and stacks, functions calls, and/or the like.

In some embodiments, the security process 74 includes a shadow memory 76 (e.g., established in the memory device 16) in which data from the production process 72 is copied. For example, the memory 76 may include copies of the stack, heap, and data of the production process 72. In addition, the security process 74 may include a runtime history 78 in which the machine state and/or text data of the production process 72 is copied. The security process 74 may also include its own process data, variables, or structures such as stack, heap, data, and text.

The security process 74 may monitor the activities of the production process 72 by examining and validating the data contained in the shadow memory 76, comparing the data stored in the shadow memory 76 to the memory of the production process 72, examining the runtime history 78 for security events such as jumps to restricted memory areas, and/or the like. In addition, once a security event has been detected by the security processor 14, the security process may perform an amount of “self-heal” to return the computer system 10 to a safe operating condition by coping a portion of the shadow memory 76 over the corresponding memory locations of the production processor 12 as discussed in more detail below in regard to FIG. 7.

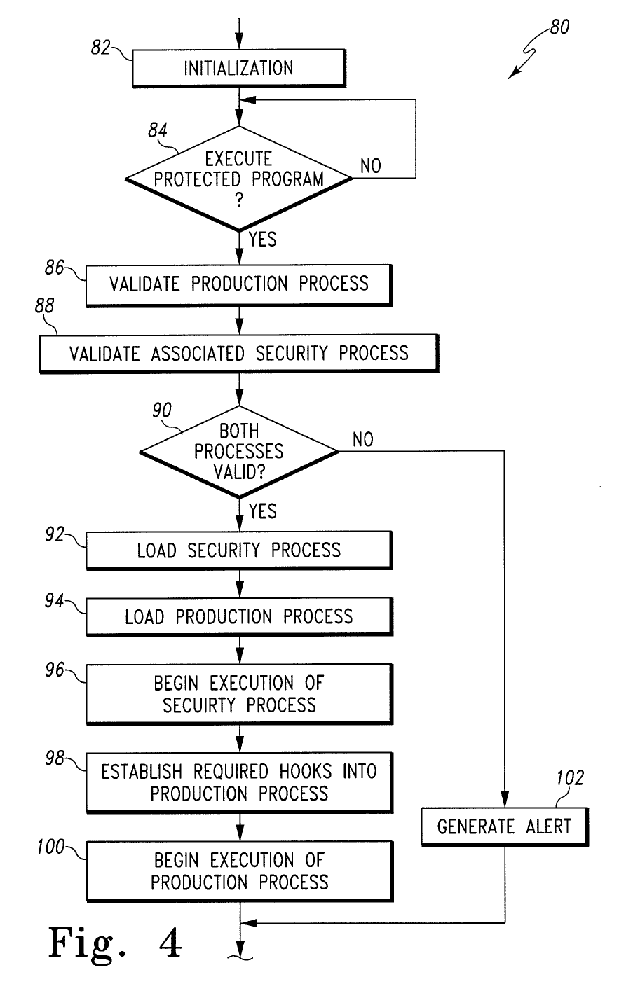

Because the security of the computer system 10 may be comprised even from the beginning execution of a process, the system 10 may execute an algorithm 80 for loading and executing a protected production process as illustrated in FIG. 4. The algorithm 80 begins with a process step 82 in which initialization functions are performed. For example, the operating system may be loaded by the computer system 10 or otherwise initialized in step 82. Next, in process step 84, the computer system 10 determines if an instruction to execute a protected program, such as a web server program, has been received. If so, the algorithm 80 advances to process step 86 in which the integrity of the production process to be executed is validated. Additionally, in process step 88, the integrity of the security process associated with the production process is validated. The production process and the associated security process may be validated by use of a pre-computed cryptographic signature or other validation mechanism. Regardless, the validation of the protected production process and the associated security process is determined in process 90.

If both processes are validated, the security process associated with the protected production process is loaded first into the memory 16 of the system 10 in process step 92. Once the security process has been loaded, the protected production program is subsequently loaded into the memory 16 in process step 94. In process step 96, the execution of the security process is initiated on the security processor 14. The security processes establishes any hooks or other security related mechanisms required by the security process into the production process' memory space and operating environment. For example, the security process may establish a wrapper around the library and system calls of the production process. In addition, the invariants of any protected variables are determined. As discussed below in more detail in regard to FIG. 5, such invariants may be coded into the security process or may be subsequently communicated thereto by the production processor.

After the security process has successfully established all the required security mechanisms in the production process, the execution of the production process is initiated on the production processor 12 in step 100. In addition, the algorithm 80 continues to ensure that the associated security process is being executed by the security processor 14 whenever the production process is being executed by the production processor 12. Once the security process and production process are properly loaded and executing, the algorithm 80 completes execution.

Referring back to process step 90, if both programs are not valid, the algorithm 80 advances to process step 102 in which an alert is generated that a security event has been detected. For example, an alert may be generated to notify an operator of the system 10 of the validation error. Such alert may be embodied as a visual notification on a display device of the system 10, an audible notification, or any other type of notification capable of informing the operator that a validation error has occurred. If an error has occurred, the algorithm 80 subsequently terminates after the alert has been generated. It should be appreciated that if a validation error security event does occur, the production process is not loaded into memory (i.e., process step 94 is skipped).

The security process may use any one or more techniques for detection of a security event (e.g., an intrusion, attack, or misuse). For example, the security process may use direct memory monitoring and inspection of the interaction between the production process and the environment in which the production process is executed. If system 10 is an SMP architecture system, components of the system 10, such as memory, are shared amongst the processors 13. The security processor 14, therefore, can be given direct access to the memory of the production process. The security process can thereby monitor the memory of the production process for changes indicating security error events have occurred. Because the security process will be actively monitoring the memory of the production process while any security error occurs, the production process can be promptly terminated or stopped from further execution.

One method usable by a security process to detect and respond to a security event is to monitor key or “critical” variables in an associated protected process. The security process may be configured to monitor, for example, changes to the variable and determine that a security event has occurred if the variable is changed to a value outside of a predetermined range. To do so, an algorithm 110 for determining invariants for critical variables may be executed by the computer system 10. The algorithm 110 begins with a process step 112 in which the critical variables used by the associated production process are determined. The critical variables may include any variable used by the production process which has the capability of causing a security event if changed or other modified to an invalid value or state. The critical variables may be determined based on an analysis of the production process or may be predefined variables which are considered critical variables across all production processes.

Once the critical variables for the relevant production process has been determined, the invariants for each of the critical variables are determined in process step 114. The invariant of a critical variable may be embodied as the valid range of values for the variable, the valid type of the variable (e.g., floating number, integer number, string, etc.), number of modifications allowed, or any other limitations or rules applicable to the critical variable. By defining an invariant for a critical variable, the system 10 (or operator of the system 10) defines a range of values or conditions that if violated result in a security event (e.g., an error or threat to the security of the system 10). Once the invariants for each critical variable is known, such data may be incorporated into the associated security process in process step 116. This may be done, for example, at the time of compiling of the security process. Once the security process is encoded with the invariant data, the security process is able to monitor the critical variables and react to a security event involving such variables. For example, if the production process attempts to modify the value of a critical variable to a value outside of a predetermined range, the security process is capable of determining that such a modification is invalid and react appropriately by, for example, causing the production process to terminate.

In addition to incorporating the invariant data into the security process, the invariant data may be passed to or otherwise communicated to the security process by the production process during run-time as shown in process step 118. In such embodiments, the production process is configured to communicate invariant data concerning variables, which are about to be modified by the production process. As discussed above, the security process is able to then monitor the critical variables and react to a security event involving such variables based on the invariant data.

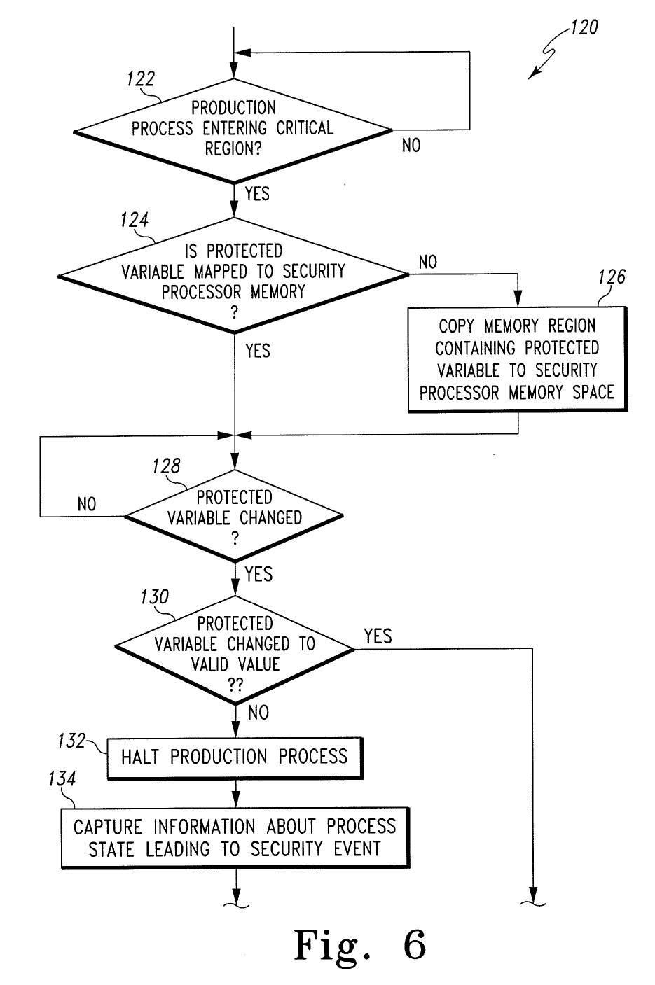

In use, the security processor 14 may monitor the “critical” variables in a protected process by executing an algorithm 120 as illustrated in FIG. 6. The algorithm 120 begins with a process step 122 in which the security process determines if the protected production process is entering a region in which a monitored variable may be modified. The monitored variable may be any variable by which the security process can identify that a security event has occurred. The security process may be notified via notification code embedded in the production process. Alternatively, the security process may be establish a “tripwire” in the instruction stream of the production process or on the monitored variable's memory location.

For most statically defined variables (i.e., variables in which the location is known at load-time) the security process may have an appropriate mapping of the variable's location in the memory space of the security process. For dynamic variables which are created at run-time, the mapping and associated unmapping of the variable to the memory of the security process will occur at run-time. Accordingly, in process step 124, the algorithm 120 determines if the monitored variable is mapped in the memory of the security process. If not, the memory region containing the monitored variable is mapped into the memory space of the security process in process step 126. Subsequently, in process step 118, the security process monitors the variable for any changes. The security process may monitor the variable while the changes are occurring or may occur after the variable has been altered but before the changed variable is used by the production process.

In process step 130, the security process determines if a security event has occurred. For example, the security process may determine if the monitored variable was changed to an illegitimate value. Alternatively, other criteria such as buffer overflow may be monitored in process step 130 to determine if a security event has occurred. If the monitored variable was changed to a legitimate value, the production process is allowed to continue and the algorithm 130 completes execution. If, however, the monitored variable was changed to an illegitimate value, the algorithm 120 advances to process step 132 in which the production process is halted. Next, in process step 134, an alert is initiated to inform an operator of the system 10 that a security event has occurred and information concerning the process state of the production process that initiated the security error is captured and stored. Further, in other embodiments, additional reactive measures may occur in process step 134. For example, the security process may initiate a “self-heal” algorithm in an attempt to return the computer system 10 to a secure operating condition. The alert may be embodied as a visual, audible, or other type of alter capable of informing the operator of the security error. Once the alert has been raised, the algorithm 130 completes execution.

Referring now to FIG. 7, once a security event has occurred, the security processor 14 may be configured to execute an algorithm 150 for returning the computer system 10 to a secure operating condition. For example, if a buffer or stack overflow error occurs, the security processor 14 may execute the algorithm 150 to overwrite the erroneous buffer or stack. The algorithm 150 begins with a process step 152 in which the security processor 14 determines if an overflow security event has occurred. As discussed above, the overflow security event may be embodied as a buffer overflow, a stack overflow, or the like. If the security processor determines that an overflow security event has occurred, the algorithm 150 advances to process step 154 in which the security processor 14 determines the relevant memory region of the relevant buffer, stack, or other memory location wherein the overflow error occurred in process step 154. Subsequently, in process step 156, the security processor 14 copies the portion of the shadow memory 76 to the corresponding memory locations of the production process in process step 156. Additionally, in sub-process step 158, the security process ensures that the buffer or stack wherein the overflow error occurred is copied back to the memory of the production process only up to the size limit of the relevant buffer or stack. In this way, the security process ensures that the overflow condition is removed and the computer system 10 is returned to a secure operating condition.

It should be appreciated that other techniques may be used by a security process to detect and respond to security errors. For example, the security process may detect the entry into prohibited or restricted regions of a program. The security process may monitor such regions by polling through a list of key data structures in the protected process and verifying any invariants of the data structures. Alternatively, the security process may use triggers. A message queue may be established for program events. The production process sends messages to the queue upon every function call and when an assertion is checked. The security process monitors the queue and responds to security errors identified via the queue. Checkpoints may be established in the program to prompt the production process to notify the queue. The checkpoints may be embodied as notification only checkpoints in which the production process stores a message in the queue notifying the security process that a protected area of the program has been entered. Alternatively, the checkpoints may be embodied as notification and blocking checkpoints in which the security process is notified via the queue and the production process further blocks entry into the protected area via a mutex or the like. Checkpoints may be established in any location in the program. For example, in known “dangerous” portions of the program, a large number of checkpoints may be established to provide a fine detail of inspection. In less “dangerous” portions of the program, the number of checkpoints may be reduced. Checkpoints may be established before and/or after key data structure, in honey pot code wherein the portion of the code should not be entered or only entered from predetermined locations, or randomly located.

The security process may monitor the queue stream of data via a number of methods. For example, the security process may monitor the stream for checkpoints that have been entered which are prohibited. Additionally, the security process may monitor changes to data structures occurring between a set of checkpoints to validate the integrity of the data. Further, the security process may use a sliding window over the queue stream to perform near-real-time sense of self form of anomaly detection. Additionally, a bit map may be used to checkpoint the production process. For example, when the production process enters a checkpoint, data is written to the bitmap. The security process monitors the bitmap via the shared memory and responds to any security errors determined therefrom. Yet further, an assertion may be used in the production process and the signal or value determined based on the assertion may be provided to the security process to allow the security process to analyze the signal or value for security errors.

The security process may monitor any one or more of a number of data items of the system 10 including registers, memory, checkpoint data, system calls, runtime library calls, data items in the protected process, and runtime execution history. The registers monitored by the security process may include the instruction pointer, the stack base pointer, and the top-of-stack pointer of the production process. For example, the security process may determine where the production process is executing based on the instruction pointer. The instruction pointer may be captured by the security process systematically or may be provided to the security process via, for example, checkpoints in the production process.

The security process may monitor the memory of the production process via knowledge of what memory locations are being used by the production process and, in some implementations, validity of the data contained in the memory locations. For example, a list of key variables may be generated along with a range of legitimate values for each variable when the program is compiled. The security process may monitor the variables stored in the memory locations for variance outside of the legitimate values. Further, artificial immune system techniques may be used to perform anomaly detection based upon memory usage patterns as well as patterns of data stored in the process' memory space.

As discussed above, checkpoints may be used by the security process to determine valid operation of the production process. The production process may pass data to a queue or directly to the security process when a checkpoint is reached. Such data may be checkpoint identifier data and may also include other information about the program state at the time when the checkpoint was entered. Checkpoints may be established in any location of the program. For example, a number of checkpoints may be established before and after a key area of the program.

The security process may use the system call entry point to capture the instruction pointer of the calling code as well as additional information about parameters. This information may be used to augment the checkpoint data as well as perform anomaly detection by verifying that the system call is allowed and is called from a legitimate location in the process' text segment. Similarly, library calls may be monitored by the security process and validated based on a list of allowed library calls and calling locations. Further, runtime execution of the production process may be stored and monitored or examined by the security process. Such examination may include artificial immune system analysis to detect anomies in the runtime history. Accordingly, it should be appreciated that the security process may use any number of techniques for verifying the validity of the production process and determining the existence of a security error.

While the disclosure has been illustrated and described in detail in the drawings and foregoing description, such an illustration and description is to be considered as exemplary and not restrictive in character, it being understood that only illustrative embodiments have been shown and described and that all changes and modifications that come within the spirit of the disclosure are desired to be protected.

There are a plurality of advantages of the present disclosure arising from the various features of the system and method described herein. It will be noted that alternative embodiments of the system and method of the present disclosure may not include all of the features described yet still benefit from at least some of the advantages of such features. Those of ordinary skill in the art may readily devise their own implementations of the system and method that incorporate one or more of the features of the present invention and fall within the spirit and scope of the present disclosure as defined by the appended claims.

1. A multiprocessor computer comprising:
a first processor configured to execute a production process; and
a second processor electrically coupled to the first processor and configured to execute a security process associated with the production process, the security process causing the second processor to monitor the operations of the first processor for an occurrence of a security event.

2. The multiprocessor computer of claim 1, wherein the first and second processors are configured for symmetric multiprocessing.

3. The multiprocessor computer of claim 1, wherein the second processor is dedicated to security related processes.

4. The multiprocessor computer of claim 1, wherein the second processor is configured to execute the security process prior to the execution of the production process by the first processor.

5. The multiprocessor computer of claim 1, wherein the security process causes the second processor to determine if a predetermined variable is modified to an invalid value by the production process.

6. The multiprocessor computer of claim 1, wherein the security process further causes the second processor to halt the execution of the production process if the security event occurs.

7. The multiprocessor computer of claim 6, wherein the security process further causes the second processor to copy data from a memory location of the second processor to a memory location of the first processor if the security event occurs.

8. The multiprocessor computer of claim 1, wherein the security event comprises an overflow error.

9. The multiprocessor computer of claim 1, wherein the security process causes the second processor to monitor a register of the first processor.

10. The multiprocessor computer of claim 1, wherein the production process includes a number of checkpoints and the production process causes the first processor to communicate with the second processor when a checkpoint is reached.

11. The multiprocessor computer of claim 1, wherein the production process causes the first processor to communicate with the second processor prior to performing a predetermined operation.

12. The multiprocessor computer of claim 1, wherein the security process generates an alert if the security event occurs.

13. A method for detecting a security event on a multiprocessor computer, the method comprising:
executing a production process on a first processor of the multiprocessor computer; and
executing a security process on a second processor of the multiprocessor computer; and
monitoring the operations of the production process using the security process for an occurrence of the security event.

14. The method of claim 13, wherein executing the security process comprises executing a security process on the second processor prior to execution of the production process.

15. The method of claim 13, wherein monitoring the operations of the production process comprises monitoring a predetermined variable used by the production process and generating an alert if the variable is modified by the production process to an invalid value.

16. The method of claim 13, wherein monitoring the operations of the production process comprises monitoring a register used by the first processes.

17. The method of claim 13, further comprising halting the execution of the production process if the security event occurs.

18. The method of claim 13, further comprising copying data from a memory location of the second processor to a memory location of the first processor if the security event occurs.

19. The method of claim 13, further comprising generating an alert if the security event occurs.

20. A computer system comprising:
a first processor; and
a second processor electrically coupled to the first processor and configured to execute a security process to monitor the operations of the first processor.
